(19) United States
(12) Patent Application Publication
(10) Pub. No.: US 2018/0025197 A1
(43) Pub. Date: Jan. 25, 2018

(54) SENSING ELEMENT AND FINGERPRINT SENSOR COMPRISING THE SENSING ELEMENTS

(71) Applicant: IMAGE MATCH DESIGN INC., HSINCHU COUNTY (TW)

(72) Inventors: YEN-KUO LO, TAINAN CITY (TW); CHIA-HUA YEH, HSINCHU CITY (TW)

(21) Appl. No.: 15/214,924

(22) Filed: Jul. 20, 2016

(51) Int. Cl. G06K 9/00; G06F 3/041; G06F 3/044

(52) U.S. Cl. CPC G06K 9/0002; G06F 3/044; G06F 3/0416; G06F 2203/04107

(57) ABSTRACT

A fingerprint sensor comprises a substrate, a first sensing electrode over the substrate, a second sensing electrode spaced apart from the first sensing electrode over the substrate, a first conductive plate and a second conductive plate. The first sensing electrode is configured to detect a capacitance in response to a touch event on the fingerprint sensor, and to receive an input signal from a signal source. The second sensing electrode is configured to detect a capacitance in response to the touch event. The first conductive plate is configured to shield at least a portion of each of the first sensing electrode and the second sensing electrode from the substrate. The second conductive plate is disposed between the substrate and the second sensing electrode. The sensitivity of the fingerprint sensor is inversely proportional to the capacitance between the second sensing electrode and the second conductive plate.

### TECHNICAL FIELD

The present disclosure is generally related to a sensing element and, more particularly, to a fingerprint sensor comprising the sensing elements.

### BACKGROUND

Touch devices or touchscreens have been commonly used in electronic devices such as smart phones, personal computers and game consoles. Some touch devices not only provide a user friendly interface and bring users convenience, but also work in conjunction with a fingerprint sensor for the purpose of data security. For example, the fingerprint sensor can determine whether a user is authorized to use the electronic device by verifying the user's identity in the form of fingerprint. Therefore, touch sensitivity has been the subject of interest in developing advanced touch devices.

### SUMMARY

Embodiments of the present invention provide a fingerprint sensor that comprises a substrate, a first sensing electrode, a second sensing electrode, a first conductive plate and a second conductive plate. The first sensing electrode, disposed over the substrate, is configured to detect a capacitance in response to a touch event on the fingerprint sensor, and to receive an input signal from a signal source. The second sensing electrode, spaced apart from the first sensing electrode over the substrate, is configured to detect a capacitance in response to the touch event. The first conductive plate is configured to shield at least a portion of each of the first sensing electrode and the second sensing electrode from the substrate. The second conductive plate is disposed between the substrate and the second sensing electrode. The sensitivity of the fingerprint sensor is inversely proportional to the capacitance between the second sensing electrode and the second conductive plate.

The fingerprint sensor further comprises an amplifier. The amplifier includes an inverting terminal coupled to the second sensing electrode, and an output coupled to the second conductive plate and, via a switch, to the second sensing electrode.

In an embodiment, a parasitic capacitance between the first sensing electrode and the second sensing electrode, and a capacitance between the first conductive plate and each of the first sensing electrode and the second sensing electrode form a capacitor network between the signal source and the inverting terminal of the amplifier.

The sensitivity of the fingerprint sensor is independent of the parasitic capacitance. Moreover, the sensitivity of the fingerprint sensor is independent of the capacitance between the first conductive plate and each of the first sensing electrode and the second sensing electrode. In addition, the amplifier includes a non-inverting terminal configured to receive a reference voltage, and the sensitivity of the fingerprint sensor is independent of the reference voltage.

In an embodiment, the sensitivity (ΔVout) of the fingerprint sensor is defined by the following equation:

$$Δ Vout = \frac{( \frac{CF}{2} )}{c 2} \times Vin$$

where Vin represents the input signal, CF represents the capacitance in response to the touch event, and C2 represents the capacitance between the second sensing electrode and the second conductive plate.

Some embodiments of the present invention provide a sensing element in a fingerprint sensor. The sensing element comprises a first sensing electrode, a second sensing electrode, a first conductive plate, a second conductive plate and an amplifier. The first sensing electrode receives an input signal from a signal source. The second sensing electrode is spaced apart from the first sensing electrode. The second sensing electrode and the first sensing electrode function to detect a capacitance in response to a touch event on the fingerprint sensor. The first conductive plate overlaps at least a portion of each of the first sensing electrode and the second sensing electrode. The second conductive plate defines a capacitance with respect to the second sensing electrode. The amplifier includes an input terminal coupled to the second sensing electrode, and an output coupled to the second conductive plate and, via a switch, to the second sensing electrode.

The sensitivity of the fingerprint sensor is inversely proportional to the capacitance between the second sensing electrode and the second conductive plate.

The fingerprint sensor according to the embodiments of the invention alleviates or eliminates the adverse effect of parasitic capacitance on the sensitivity of the fingerprint sensor. Effectively, the sensitivity is independent of an undesired parasitic capacitance between the first sensing electrode and the second sensing electrode. Moreover, the sensitivity of the fingerprint sensor, represented by ΔVout, is inversely proportional to the capacitance C2 between the second sensing electrode and the second conductive plate. As a result, to enhance the sensitivity of the fingerprint sensor, the capacitance C2 can be adjusted by, for example, increasing the distance between the second sensing electrode and the second conductive plate, reducing the overlapped area between the second sensing electrode and the second conductive plate, or using a low-k insulating material between the second sensing electrode and the second conductive plate. The dimensions of the second sensing electrode and the second conductive plate, the distance therebetween, and the insulating material can be determined, for example, at a layout design stage of the fingerprint sensor.

The foregoing has outlined rather broadly the features and technical advantages of the present invention in order that the detailed description of the invention that follows may be better understood. Additional features and advantages of the invention will be described hereinafter. It should be appreciated by persons having ordinary skill in the art that the conception and specific embodiments disclosed may be readily utilized as a basis for modifying or designing other structures or processes for carrying out the same purposes of the present invention without departing from the spirit and scope of the invention as set forth in the appended claims.

### BRIEF DESCRIPTION OF THE DRAWINGS

Details of one or more embodiments of the disclosure are set forth in the accompanying drawings and the description below. Other features and advantages of the disclosure will be apparent from the description, drawings and claims. Throughout the various views and illustrative embodiments, like reference numerals are used to designate like elements. Reference will now be made in detail to exemplary embodiments illustrated in the accompanying drawings.

FIG. 1 is a top view of a fingerprint sensor in accordance with some embodiments of the present invention.

FIG. 2A is a schematic diagram of an exemplary sensing element of the fingerprint sensor shown in FIG. 1, in accordance with some embodiments of the present invention.

FIG. 2B is a circuit diagram of an equivalent circuit of the exemplary sensing element shown in FIG. 2A, in accordance with some embodiments of the present invention.

FIG. 3A is a circuit diagram of the exemplary sensing element shown in FIG. 2A, operating in a first phase in the absence of a touch event in accordance with some embodiments of the present invention.

FIG. 3B is a circuit diagram of an equivalent circuit of the exemplary sensing element shown in FIG. 3A, operating in the first phase in the absence of a touch event.

FIG. 4A is a circuit diagram of the exemplary sensing element shown in FIG. 2A, operating in a second phase in the absence of a touch event in accordance with some embodiments of the present invention.

FIG. 4B is a circuit diagram of an equivalent circuit of the exemplary sensing element shown in FIG. 4A, operating in the second phase in the absence of a touch event.

FIG. 5A is a circuit diagram of the exemplary sensing element shown in FIG. 2A, operating in a first phase in the presence of a touch event in accordance with some embodiments of the present invention.

FIG. 5B is a circuit diagram of an equivalent circuit of the exemplary sensing element shown in FIG. 5A, operating in the first phase in the presence of a touch event.

FIG. 6A is a circuit diagram of the exemplary sensing element shown in FIG. 2A, operating in a second phase in the presence of a touch event in accordance with some embodiments of the present invention.

FIG. 6B is a circuit diagram of an equivalent circuit of the exemplary sensing element shown in FIG. 6A, operating in the second phase in the presence of a touch event.

FIG. 7A is a circuit diagram of an equivalent circuit of the exemplary sensing element shown in FIG. 3A, operating in the first phase in the absence of a touch event in accordance with another embodiment of the present invention.

FIG. 7B is a circuit diagram of an equivalent circuit of the exemplary sensing element shown in FIG. 4A, operating in the second phase in the absence of a touch event in accordance with another embodiment of the present invention.

FIG. 8A is a circuit diagram of an equivalent circuit of the exemplary sensing element shown in FIG. 5A, operating in the first phase in the presence of a touch event in accordance with another embodiment of the present invention.

FIG. 8B is a circuit diagram of an equivalent circuit of the exemplary sensing element shown in FIG. 6A, operating in the second phase in the presence of a touch event in accordance with another embodiment of the present invention.

### DETAIL DESCRIPTION

In order to make the disclosure comprehensible, detailed steps and structures are provided in the following description. Obviously, implementation of the disclosure does not limit special details known by persons skilled in the art. In addition, known structures and steps are not described in detail, so as not to limit the disclosure unnecessarily. Preferred embodiments of the disclosure will be described below in detail. However, in addition to the detailed description, the disclosure may also be widely implemented in other embodiments. The scope of the disclosure is not limited to the detailed description, and is defined by the claims.

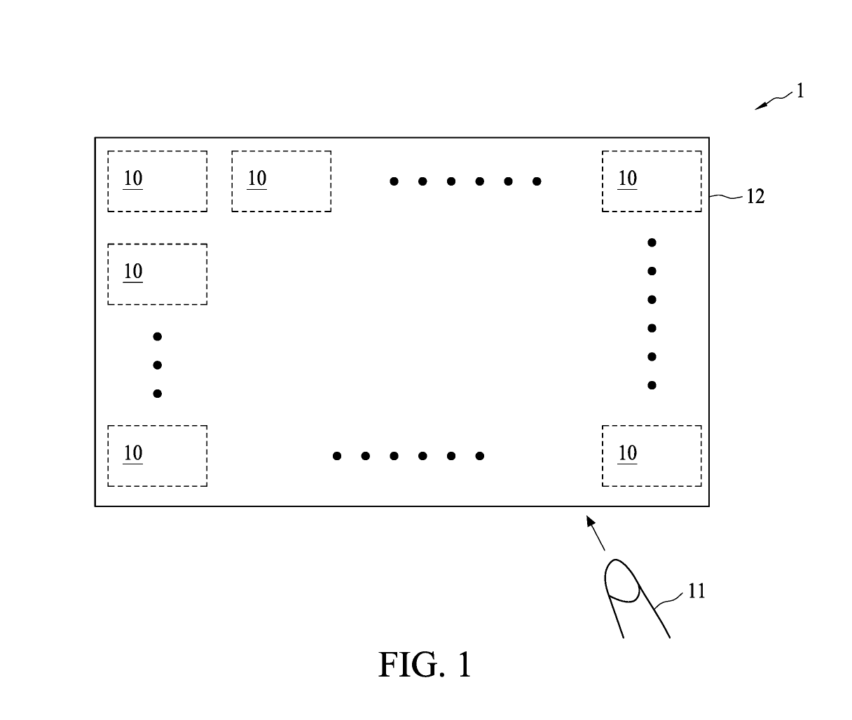

FIG. 1 is a top view of a fingerprint sensor 1 in accordance with some embodiments of the present invention. The fingerprint sensor 1 is adapted to work with an electronic device (not shown), such as a smart phone, a personal computer and a personal digital assistant. Referring to FIG. 1, the fingerprint sensor 1 includes an array of sensing elements 10, which are covered by a protection layer 12. The sensing elements 10 are configured to detect a touch event of an object 11, such as a stylus, pen or one or more fingers, when tapping or moving across the surface of the protection layer 12.

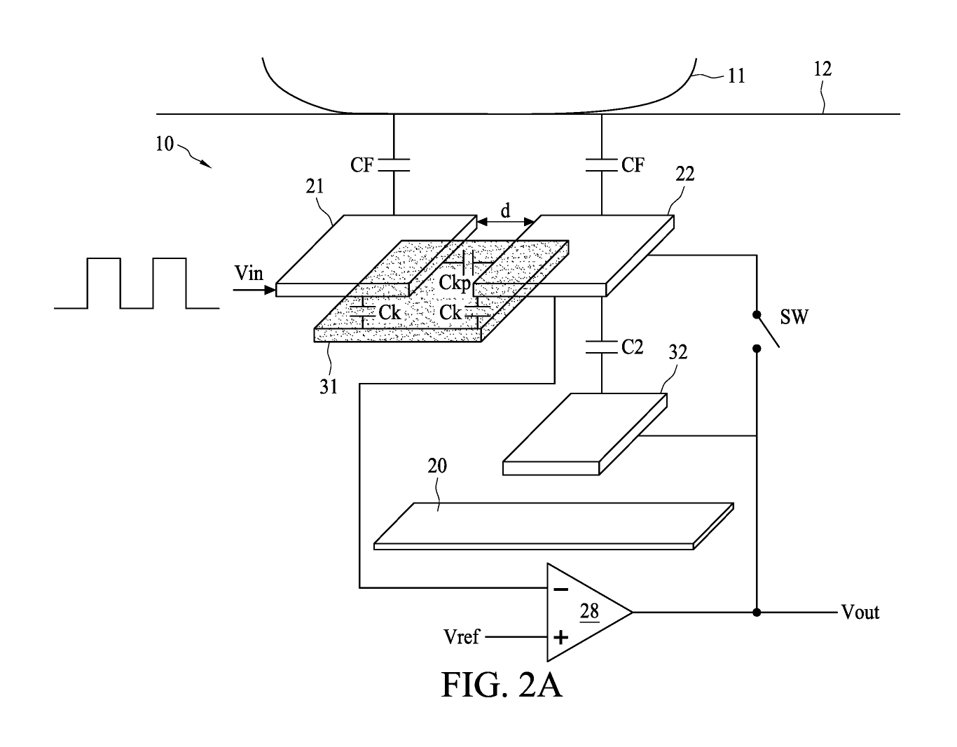

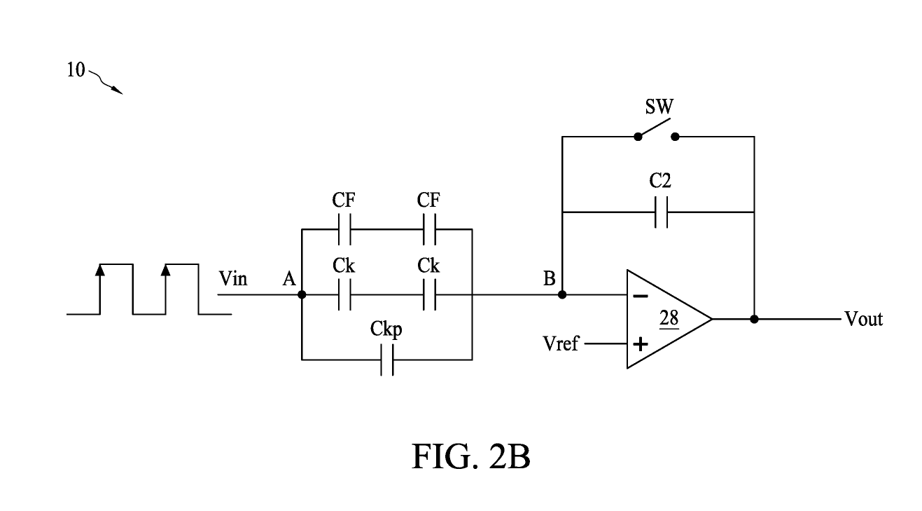

FIG. 2A is a schematic diagram of an exemplary sensing element 10 of the fingerprint sensor 1 shown in FIG. 1, in accordance with some embodiments of the present invention. Referring to FIG. 2A, the exemplary sensing element 10 includes a first sensing electrode 21, a second sensing electrode 22, a first conductive plate 31, a second conductive plate 32, an amplifier 28 and a switch SW, which are all disposed over or in a substrate 20, as will be discussed later.

The first sensing electrode 21, disposed near the protection layer 12, is configured to detect a capacitance CF associated with the object 11 in response to a touch event on the fingerprint sensor 1. For convenience, a same reference numeral or label for a capacitor is also used for its capacitance throughout the specification, and vice versa. For example, while the reference label “CF” as above mentioned refers to a capacitance, it may represent a capacitor having the capacitance. Moreover, the first sensing electrode 21 is configured to receive an input signal Vin from a signal source (not shown). The signal source may be disposed externally to the fingerprint sensor 1 and applies the signal Vin to the first sensing electrode 21. Alternatively, the signal source is formed internally in the fingerprint sensor 1 and excited via a metal ring. Further, due to the driving ability of the signal source, parasitic capacitances between the substrate 20 and each of the first sensing electrode 21, second sensing electrode 22 and first conductive plate 31 can be neglected.

The second sensing electrode 22, disposed near the protection layer 12 and spaced apart from the first sensing electrode 21, is also configured to detect a capacitance associated with the object 11 in response to a touch event on the fingerprint sensor 1. The second sensing electrode 22 and the first sensing electrode 21 are juxtaposed in a same conductive layer, for example, a metal-4 (M4) layer over the substrate 20. Further, the first sensing electrode 21 and the second sensing electrode 22 are separated from one another by a distance “d.” As a result, a parasitic capacitance Ckp exists between the first sensing electrode 21 and the second sensing electrode 22. In the present embodiment, for convenience, the second sensing electrode 22 has substantially the same size as the first sensing electrode 21 and thus a same capacitance CF associated with the object 11 can be detected when a touch event occurs. In another embodiment, however, the second sensing electrode 22 may have a different size from the first sensing electrode 21. Nevertheless, the different size of the second sensing electrode 22 may be predetermined so that the detected capacitance is proportional to the capacitance CF.

In a fingerprint sensor, the value of capacitance CF depends on the geometric property of a contact surface of an object during a touch event. For example, a ridge portion of the object produces a larger capacitance than a valley portion. However, the capacitance difference may not be large enough for a fingerprint sensor to distinguish a ridge from a valley or vice versa. Moreover, parasitic capacitances such as Ckp may even lessen the difference and worsen the sensing result. In the present disclosure, the parasitic capacitance Ckp may adversely affect the sensitivity of the fingerprint sensor 1. It is desirable that the effect of Ckp can be alleviated or even eliminated, as will be further discussed in detail.

The first conductive plate 31, disposed between the substrate 20 and the conductive layer of the first and second sensing electrodes 21, 22, is configured to shield at least a portion of each of the first sensing electrode 21 and the second sensing electrode 22 from the substrate 20. Specifically, the first conductive plate 31 extends in a conductive layer, for example, a metal-3 (M3) layer over the substrate 20 and overlaps the first sensing electrode 21 and the second sensing electrode 22. In the present embodiment, for convenience, the first conductive plate 31 overlaps a substantially equal area with the first sensing electrode 21 and the second sensing electrode 22. As a result, a capacitance Ck exists between the first conductive plate 31 and each of the first sensing electrode 21 and the second sensing electrode 22. In another embodiment, however, the first conductive plate 31 may have a different overlapped area with the first sensing electrode 21 and the second sensing electrode 22. Accordingly, the capacitance between the first conductive plate 31 and each of the first sensing electrode 21 and the second sensing electrode 22 may be different. Nevertheless, the different overlapped area between the second sensing electrode 22 and the first conductive plate 31 may be predetermined so that the capacitance therebetween is proportional to the capacitance Ck between the first sensing electrode 21 and the first conductive plate 31.

The second conductive plate 32, disposed between the substrate 20 and the second sensing electrode 22, is configured to transmit the signal Vin via the first sensing electrode 21, second sensing electrode 22 and first conductive plate 31 to an output of the amplifier 28. In an embodiment, the second conductive plate 32 extends in a conductive layer, for example, a metal-2 (M2) layer over the substrate 20 and overlaps the second sensing electrode 22. As a result, a capacitance C2 exists between the second sensing electrode 22 and the second conductive plate 32.

The amplifier 28 is configured to facilitate determination of a fingerprint pattern based on the capacitance CF. In the present embodiment, the amplifier 28 includes an operational (OP) amplifier, as illustrated in FIG. 2A. Moreover, the amplifier 28 is disposed in an active region or active layer of the substrate 20, even though for illustration the amplifier 28 as shown appears to be outside the substrate 20. A non-inverting terminal of the amplifier 28 receives a first reference voltage Vref. An inverting terminal of the amplifier 28 is connected to the second sensing electrode 22. Further, an output of the amplifier 28 is connected to the second conductive plate 32 and, via the switch SW, to the second sensing electrode 22.

Since the input impedance of an OP amplifier is ideally indefinite, the voltage drop across the input impedance is zero and thus both input terminals are at the same potential. In other words, the two input terminals of the amplifier 28 are virtually shorted to each other, a characteristic called “virtual short.” If the non-inverting terminal of the amplifier 28 is grounded, then due to the “virtual short” between the two input terminals, the inverting terminal is also connected to ground potential, which is called “virtual ground.” Further, due to relatively high capacitive load driving ability of the amplifier 28, a parasitic capacitance between the second conductive plate 32 (which is connected to the output of the amplifier 28) and the substrate 20 can be neglected.

The switch SW may include a transistor formed in the active region of the substrate 20. A controller or microprocessor (not shown) is used to control the open or closed state of the switch SW. Further, the switch SW is connected between the second sensing electrode 22 and the second conductive plate 32, and between the second sensing electrode 22 and the output of the amplifier 28. In operation, when the switch SW is closed, the second sensing electrode 22 and the second conductive plate 32 are short-circuited, bypassing the capacitance C2 between the second sensing electrode 22 and the second conductive plate 32. As a result, the signal Vin is sent via the first sensing electrode 21, first conductive plate 31, second sensing electrode 22 towards the output of the amplifier 28. In contrast, when the switch SW is open, the signal Vin is sent via the first sensing electrode 21, first conductive plate 31, second sensing electrode 22 and the second conductive plate 32 towards the output of the amplifier 28.

FIG. 2B is a circuit diagram of an equivalent circuit of the exemplary sensing element 10 shown in FIG. 2A, in accordance with some embodiments of the present invention. Referring to FIG. 2B, capacitors CF are connected in series between a node A that receives an input signal Vin and the inverting terminal, node B, of the amplifier 28. Also, capacitors Ck are connected in series between the node A and node B. In addition, the serially connected capacitors CF, the serially connected capacitors Ck and a patristic capacitor Ckp are connected in parallel between the node A and node B. Further, capacitor C2 and the switch SW are connected in parallel between the node B and the output of the amplifier 28. Capacitors Ck and Ckp form a capacitor network between the signal source of Vin and the amplifier 28. The capacitor network further includes the capacitors CF when they are detected.

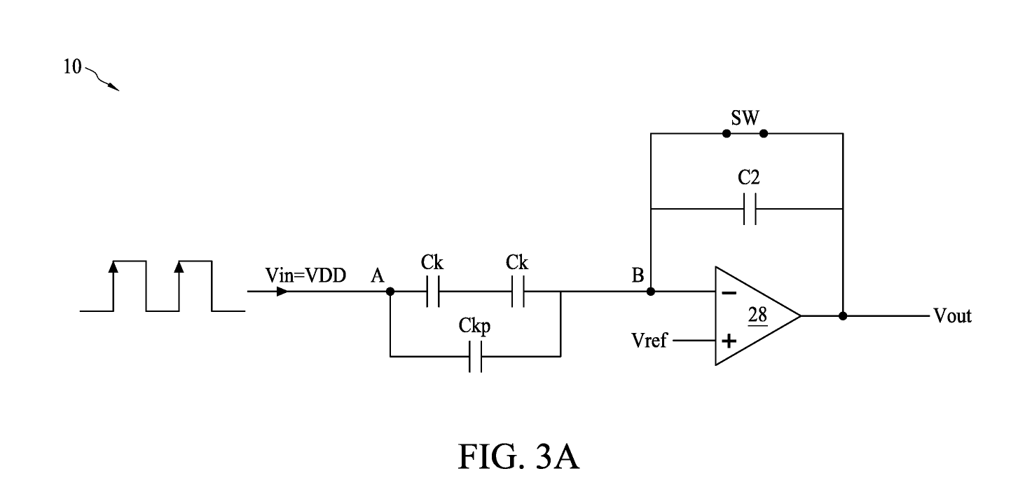

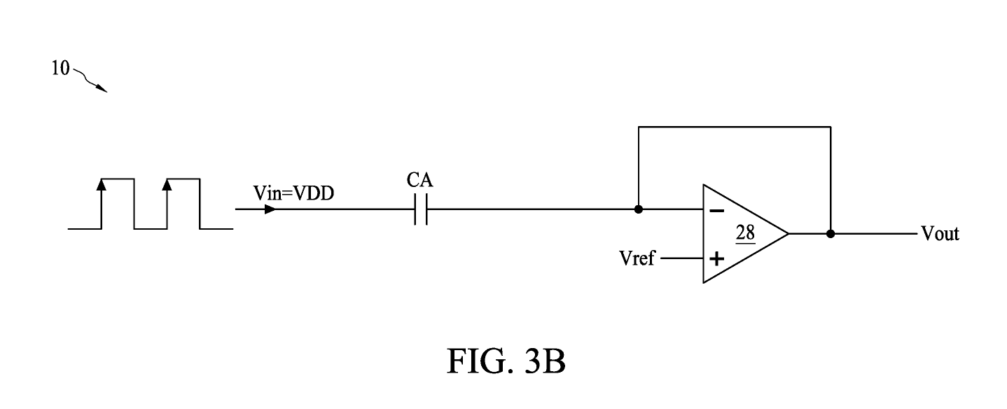

FIG. 3A is a circuit diagram of the exemplary sensing element 10 shown in FIG. 2A, operating in a first phase in the absence of a touch event in accordance with some embodiments of the present invention. Referring to FIG. 3A, during the first phase the switch SW is closed, bypassing the capacitor C2. As a result, the inverting terminal is short-circuited to the output of the amplifier 28. The amplifier 28 thus has a unity gain. In addition, CF is substantially equal to zero and omitted in FIG. 3A since no touch event is detected. In the first phase, the sensing element 10 operates in a “reset” mode. The input voltage Vin is VDD. In addition, by function of virtual short, the inverting terminal of the amplifier 28 is reset to Vref.

The signal Vin, which facilitates fingerprint detection, is applied to the node A. In some embodiments, as in the present example shown in FIG. 3A, the signal Vin is rising edge triggered and has a magnitude of VDD, which is approximately 3.3 volts (V), for example. In other embodiments, as will be further discussed, the signal Vin is falling edge triggered. In either case, with the inventive fingerprint sensor 1 according to the present invention, touch sensitivity is enhanced.

The reference voltage Vref is ideally ground potential. In practice, the reference voltage Vref has a voltage level near ground potential, for example, ranging between approximately 0.2 volt (V) and 0.3V.

FIG. 3B is a circuit diagram of an equivalent circuit of the exemplary sensing element 10 shown in FIG. 3A, operating in the first phase in the absence of a touch event. Referring to FIG. 3B, since the switch SW is closed, the capacitor C2 is bypassed and omitted in FIG. 3B. A combination of the serially connected capacitors Ck and the parasitic capacitor Ckp that are connected in parallel has an equivalent capacitance CA, as expressed in equation (1) below.

$$CA = \frac{Ck}{2} + Ckp \qquad ( 1 )$$

In operation, in response to a first state (VDD) of the signal Vin, charge is stored in the capacitor CA. The magnitude of charge, QCA1, stored in the capacitor CA at the side of the inverting terminal, can be expressed in equation (2) below.

QCA1=CA×(Vref−Vin) (2)

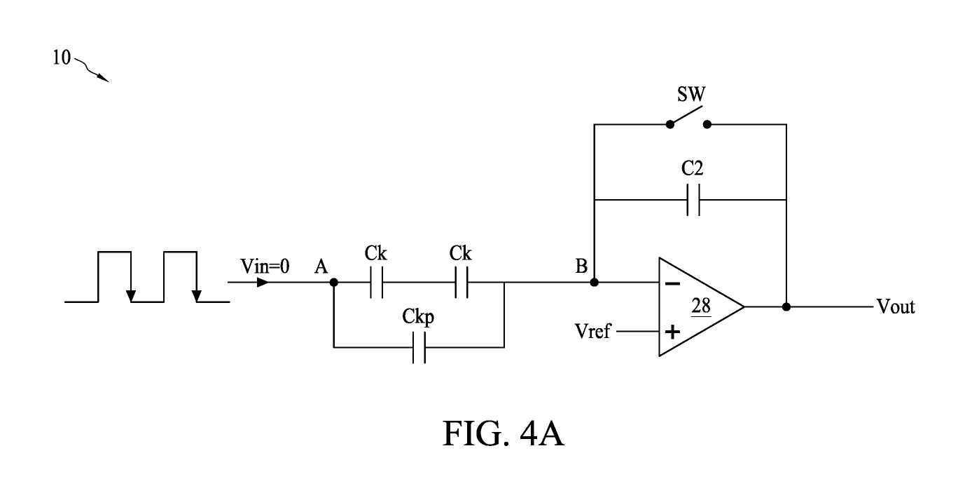

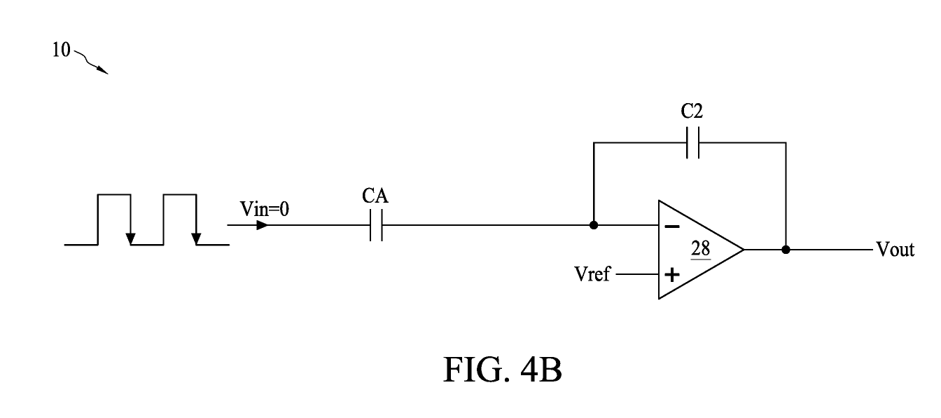

FIG. 4A is a circuit diagram of the exemplary sensing element 10 shown in FIG. 2A, operating in a second phase in the absence of a touch event in accordance with some embodiments of the present invention. Referring to FIG. 4A, during the second phase the switch SW is open, and the inverting terminal is connected via the capacitor C2 to the output of the amplifier 28. In addition, CF is substantially equal to zero since no touch event is detected. In the second phase, the sensing element 10 operates in an “amplification” mode. The input voltage Vin is approximately zero.

FIG. 4B is a circuit diagram of an equivalent circuit of the exemplary sensing element 10 shown in FIG. 4A, operating in the second phase in the absence of a touch event. Referring to FIG. 4B, in operation, in response to a second state (zero) of the signal Vin, the charge stored in the capacitor CA according to equation (2) is distributed between the capacitors CA and C2. The magnitude of charge, QCA2, stored in the capacitors CA and C2 at the side of the inverting terminal, can be expressed in equation (3) below.

QCA2=CA×(Vref−0)+C2×(Vref−Vout) (3)

According to the law of charge conservation, the magnitude of charge stored in the first phase is equal to that in the second phase in the absence of the touch event. That is, QCA1=QCA2, as further expressed in equation (4):

CA×(Vref−Vin)=CA×(Vref−0)+C2×(Vref−Vout) (4)

By rearranging equation (4), Vout can be determined in equation (5) as follows.

$$Vout = Vref + \frac{CA}{C 2} \times Vin \qquad ( 5 )$$

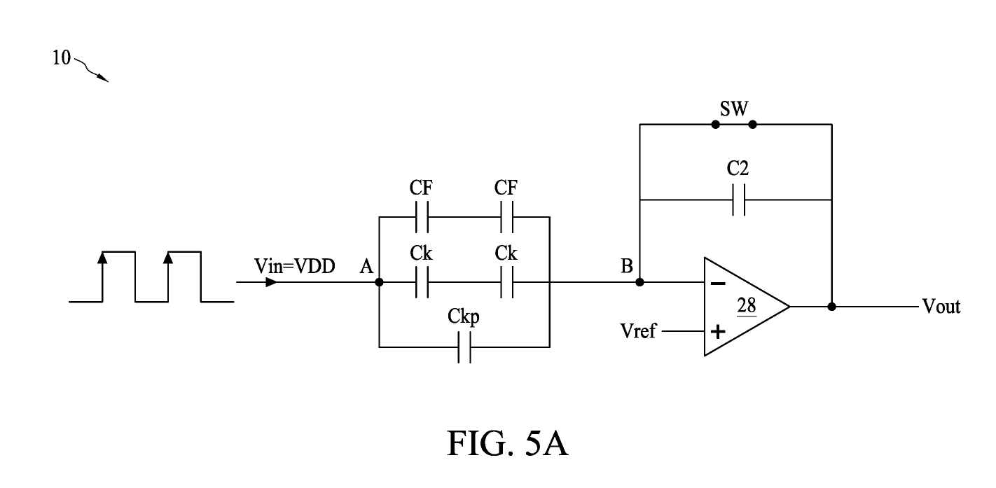

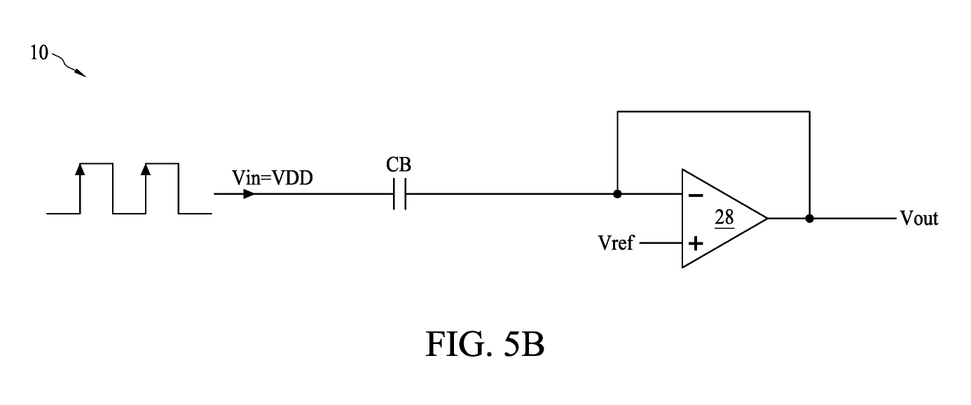

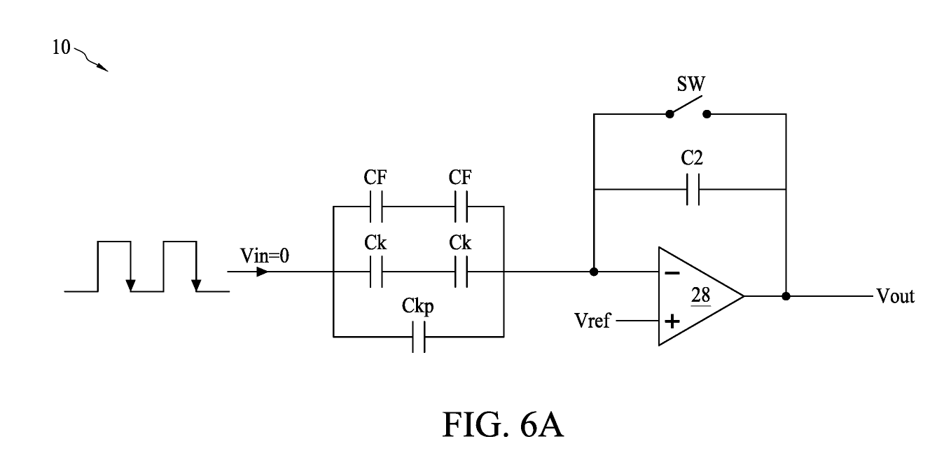

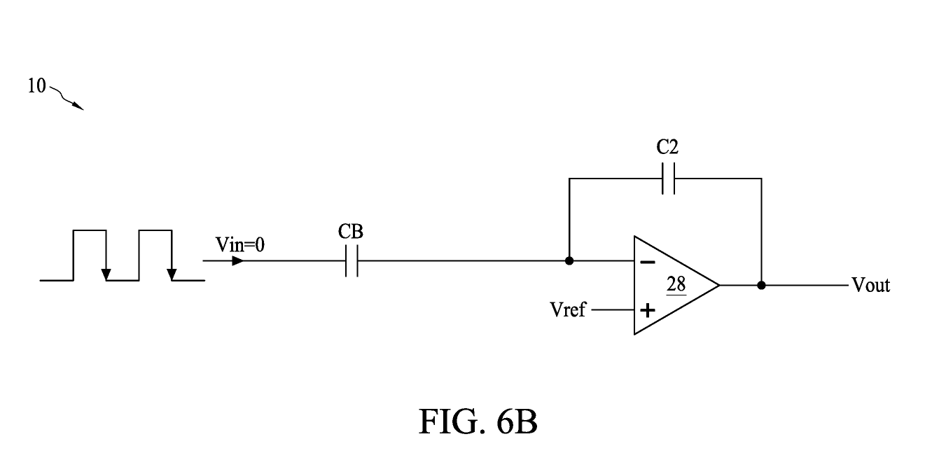

The value of Vout determined in the absence of a touch event, which has been described and illustrated with reference to FIGS. 3A, 3B, 4A and 4B, will be compared against its counterpart (Voutf) determined in the presence of a touch event, which will be described and illustrated with reference to FIGS. 5A, 5B, 6A and 6B. The difference between Vout and Voutf is defined as the sensitivity of the fingerprint sensor 1.

FIG. 5A is a circuit diagram of the exemplary sensing element 10 shown in FIG. 2A, operating in a first phase in the presence of a touch event in accordance with some embodiments of the present invention. The circuit structure shown in FIG. 5A is similar to that in FIG. 3A except that, for example, the capacitors CF are present in FIG. 5A since a touch event is detected.

FIG. 5B is a circuit diagram of an equivalent circuit of the exemplary sensing element 10 shown in FIG. 5A, operating in the first phase in the presence of a touch event. Referring to FIG. 5B, since the switch SW is closed, the capacitor C2 is bypassed and omitted in FIG. 3B. A combination of the serially connected capacitors CF, the serially connected capacitors Ck and the parasitic capacitor Ckp that are connected in parallel has an equivalent capacitance CB, as expressed in equation (6) below.

$$CB = \frac{CF}{2} + \frac{Ck}{2} + Ckp \qquad ( 6 )$$

In operation, in response to a first state (VDD) of the signal Vin, charge is stored in the capacitor CB. The magnitude of charge, QCB1, stored in the capacitor CB at the side of the inverting terminal, can be expressed in equation (7) below.

QCB1=CB×(Vref−Vin) (7)

FIG. 6A is a circuit diagram of the exemplary sensing element 10 shown in FIG. 2A, operating in a second phase in the presence of a touch event in accordance with some embodiments of the present invention. The circuit structure shown in FIG. 6A is similar to that in FIG. 4A except that, for example, the capacitors CF are present in FIG. 6A since a touch event is detected.

FIG. 6B is a circuit diagram of an equivalent circuit of the exemplary sensing element shown in FIG. 6A, operating in the second phase in the presence of a touch event. Referring to FIG. 6B, in operation, in response to a second state (zero) of the signal Vin, the charge stored in the capacitor CB according to equation (7) is distributed between the capacitors CB and C2. The magnitude of charge, QCB2, stored in the capacitors CB and C2 at the side of the inverting terminal, can be expressed in equation (8) below.

QCB2=CB×(Vref−0)+C2×(Vref−Voutf) (8)

According to the law of charge conservation, the magnitude of charge stored in the first phase is equal to that in the second phase in the presence of the touch event. That is, QCB1=QCB2, as further expressed in equation (9):

CB×(Vref−Vin)=CB×(Vref−0)+C2×(Vref−Voutf) (9)

By rearranging equation (9), Voutf can be determined in equation (10) as follows.

$$Voutf = Vref + \frac{CB}{C 2} \times Vin \qquad ( 10 )$$

The difference between Vout and Voutf, denoted ΔVout, is obtained by subtracting Vout from Voutf, as shown in equation (11):

$$Δ Vout = Voutf - Vout = \frac{CB - CA}{C 2} \times Vin = \frac{( \frac{CF}{2} )}{C 2} \times Vin \qquad ( 11 )$$

In view of equation (11), the sensitivity of the fingerprint sensor 1, represented by ΔVout, is inversely proportional to the capacitance C2 between the second sensing electrode 22 and the second conductive plate 32. As a result, by adjusting the capacitance C2, a desirable sensitivity of the fingerprint sensor 1 can be determined. Specifically, to enhance the sensitivity of the fingerprint sensor 1, in an embodiment, the distance between the second sensing electrode 22 and the second conductive plate 32 is increased, resulting in a smaller capacitance C2. In another embodiment, the overlapped area between the second sensing electrode 22 and the second conductive plate 32 is reduced, also resulting in a smaller C2. In still another embodiment, a low-k insulating material is disposed between the second sensing electrode 22 and the second conductive plate 32 to help lower the dielectric constant and hence lower the capacitance C2. For example, the dielectric constant k is smaller than 3.

Moreover, the sensitivity is independent of the undesired parasitic capacitance Ckp between the first sensing electrode 21 and the second sensing electrode 22. Also, the sensitivity is independent of the capacitance Ck between the first conductive plate 31 and each of the first sensing electrode 21 and the second sensing electrode 22. In addition, the sensitivity is independent of the reference voltage Vref.

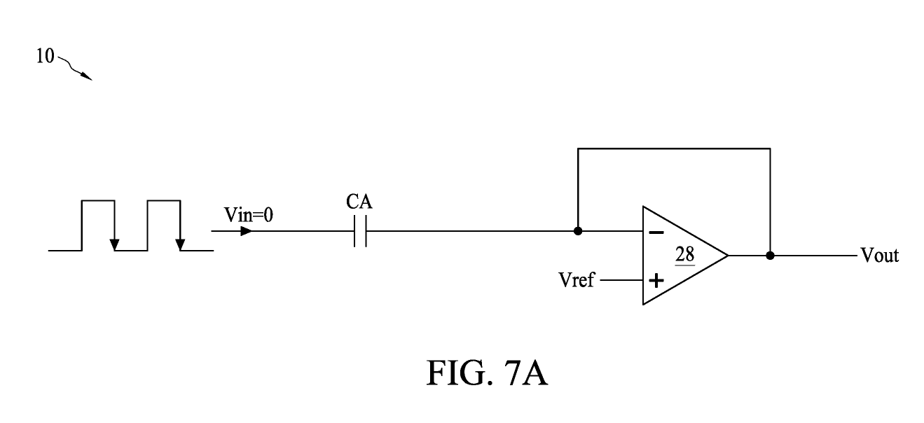

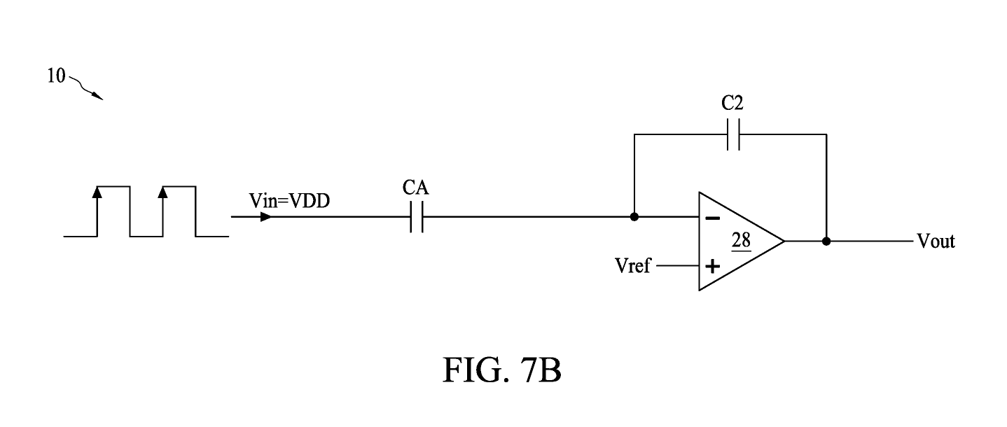

FIG. 7A is a circuit diagram of an equivalent circuit of the exemplary sensing element 10 shown in FIG. 3A, operating in the first phase in the absence of a touch event in accordance with another embodiment of the present invention. The circuit structure shown in FIG. 7A is similar to that in FIG. 3B except that, for example, the input signal Vin is falling edge triggered. In operation, in response to a first state (zero) of the signal Vin, the magnitude of charge, QCA1′ in the capacitor CA at the side of the inverting terminal, can be expressed in equation (12) below.

QCA1′=CA×(Vref−0) (12)

FIG. 7B is a circuit diagram of an equivalent circuit of the exemplary sensing element 10 shown in FIG. 4A, operating in the second phase in the absence of a touch event in accordance with another embodiment of the present invention. The circuit structure shown in FIG. 7B is similar to that in FIG. 4B except that, for example, the input signal Vin is falling edge triggered. In operation, in response to a second state (VDD) of the signal Vin, the charge stored in the capacitor CA according to equation (12) is distributed between the capacitors CA and C2. The magnitude of charge, QCA2′, stored in the capacitors CA and C2 at the side of the inverting terminal, can be expressed in equation (13) below.

QCA2′=CA×(Vref−Vin)+C2×(Vref−Vout) (13)

According to the law of charge conservation, the magnitude of charge stored in the first phase is equal to that in the second phase in the absence of the touch event. That is, QCA1′=QCA2′, as further expressed in equation (14):

CA×(Vref−0)=CA×(Vref−Vin)+C2×(Vref−Vout) (14)

By rearranging equation (14), Vout can be determined in equation (15) as follows.

$$Vout = Vref - \frac{CA}{C 2} \times Vin \qquad ( 15 )$$

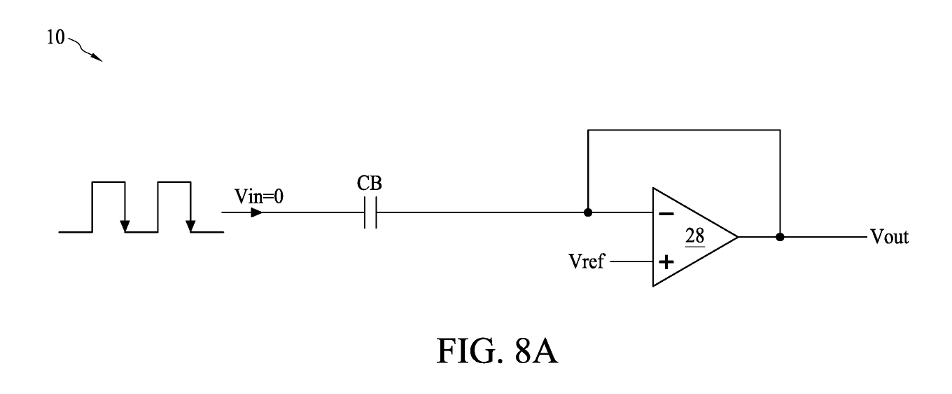

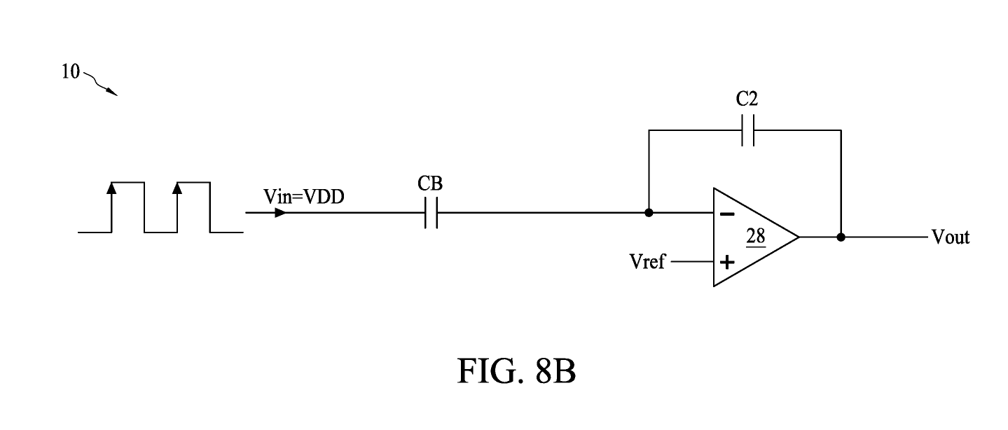

FIG. 8A is a circuit diagram of an equivalent circuit of the exemplary sensing element 10 shown in FIG. 5A, operating in the first phase in the presence of a touch event in accordance with another embodiment of the present invention. The circuit structure shown in FIG. 8A is similar to that in FIG. 5B except that, for example, the input signal Vin is falling edge triggered. In operation, in response to a first state (zero) of the signal Vin, the magnitude of charge, QCB1′, stored in the capacitor CB at the side of the inverting terminal, can be expressed in equation (16) below.

QCB1′=CB×(Vref−0) (16)

FIG. 8B is a circuit diagram of an equivalent circuit of the to exemplary sensing element 10 shown in FIG. 6A, operating in the second phase in the presence of a touch event in accordance with another embodiment of the present invention. The circuit structure shown in FIG. 8B is similar to that in FIG. 6B except that, for example, the input signal Vin is falling edge triggered. In operation, in response to a second state (VDD) of the signal Vin, the charge stored in the capacitor CB according to equation (16) is distributed between the capacitors CB and C2. The magnitude of charge, QCB2′, stored in the capacitors CB and C2 at the side of the inverting terminal, can be expressed in equation (17) below.

QCB2′=CB×(Vref−Vin)+C2×(Vref−Voutf) (17)

According to the law of charge conservation, the magnitude of charge stored in the first phase is equal to that in the second phase in the presence of the touch event. That is, QCB1′=QCB2′, as further expressed in equation (18):

CB×(Vref−0)=CB×(Vref−Vin)+C2×(Vref−Voutf) (18)

By rearranging equation (18), Voutf can be determined in equation (19) as follows.

$$Voutf = Vref - \frac{CB}{C 2} \times Vin \qquad ( 19 )$$

The difference between Vout and Voutf, denoted ΔVout, is obtained by subtracting Vout from Voutf, as shown in equation (20):

$$Δ Vout = Voutf - Vout = \frac{CA - CB}{C 2} \times Vin = \frac{- ( \frac{CF}{2} )}{C 2} \times Vin \qquad ( 20 )$$

Equation (20) is similar to equation (11) except the sign. As a result, no matter the input signal is rising edge of falling edge triggered, the sensitivity of the fingerprint sensor 1, represented by ΔVout, is inversely proportional to the capacitance C2 between the second sensing electrode 22 and the second conductive plate 32. Moreover, the sensitivity is independent of the undesired parasitic capacitance Ckp between the first sensing electrode 21 and the second sensing electrode 22. Also, the sensitivity is independent of the capacitance Ck between the first conductive plate 31 and each of the first sensing electrode 21 and the second sensing electrode 22.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims.

What is claimed is:

1. A fingerprint sensor, comprising:
a substrate;
a first sensing electrode over the substrate, configured to detect a capacitance in response to a touch event on the fingerprint sensor, and to receive an input signal from a signal source;
a second sensing electrode spaced apart from the first sensing electrode over the substrate, configured to detect a capacitance in response to the touch event;
a first conductive plate to shield at least a portion of each of the first sensing electrode and the second sensing electrode from the substrate; and
a second conductive plate between the substrate and the second sensing electrode,
wherein sensitivity of the fingerprint sensor is inversely proportional to the capacitance between the second sensing electrode and the second conductive plate.

2. The fingerprint sensor of claim 1 further comprising an amplifier, the amplifier including:
an inverting terminal coupled to the second sensing electrode; and
an output coupled to the second conductive plate and, via a switch, to the second sensing electrode.

3. The fingerprint sensor of claim 2, wherein a parasitic capacitance between the first sensing electrode and the second sensing electrode, and a capacitance between the first conductive plate and each of the first sensing electrode and the second sensing electrode form a capacitor network between the signal source and the inverting terminal of the amplifier.

4. The fingerprint sensor of claim 3, wherein the sensitivity of the fingerprint sensor is independent of the parasitic capacitance.

5. The fingerprint sensor of claim 3, wherein the sensitivity of the fingerprint sensor is independent of the capacitance between the first conductive plate and each of the first sensing electrode and the second sensing electrode.

6. The fingerprint sensor of claim 3, wherein the amplifier includes a non-inverting terminal configured to receive a reference voltage, and the sensitivity of the fingerprint sensor is independent of the reference voltage.

7. The fingerprint sensor of claim 3, wherein the capacitor network further includes capacitances detected by the first sensing electrode and the second sensing electrode.

8. The fingerprint sensor of claim 1, wherein the sensitivity (ΔVout) of the fingerprint sensor is defined by the following equation:
$$Δ Vout = \frac{( \frac{CF}{2} )}{c 2} \times Vin$$
where Vin represents the input signal, CF represents the capacitance in response to the touch event, and C2 represents the capacitance between the second sensing electrode and the second conductive plate.

9. The fingerprint sensor of claim 1 further comprising a low-k insulating layer between the second sensing electrode and the second conductive plate.

10. A sensing element in a fingerprint sensor, the sensing element comprising:
a first sensing electrode configured to receive an input signal from a signal source;
a second sensing electrode spaced apart from the first sensing electrode, the second sensing electrode and the first sensing electrode configured to detect a capacitance in response to a touch event on the fingerprint sensor;
a first conductive plate configured to overlap at least a portion of each of the first sensing electrode and the second sensing electrode;
a second conductive plate configured to define a capacitance with respect to the second sensing electrode; and
an amplifier including an input terminal coupled to the second sensing electrode, and an output coupled to the second conductive plate and, via a switch, to the second sensing electrode.

11. The sensing element of claim 10, wherein sensitivity of the fingerprint sensor is inversely proportional to the capacitance between the second sensing electrode and the second conductive plate.

12. The sensing element of claim 10, wherein sensitivity of the fingerprint sensor is independent of a parasitic capacitance between the first sensing electrode and the second sensing electrode.

13. The sensing element of claim 10, wherein sensitivity of the fingerprint sensor is independent of a capacitance between the first conductive plate and each of the first sensing electrode and the second sensing electrode.

14. The sensing element of claim 11, wherein sensitivity (ΔVout) of the fingerprint sensor is defined by the following equation:
$$Δ Vout = \frac{( \frac{CF}{2} )}{c 2} \times Vin$$
where Vin represents the input signal, CF represents the capacitance in response to the touch event, and C2 represents the capacitance between the second sensing electrode and the second conductive plate.
